(19) United States
(12) Patent Application Publication
(10) Pub. No.: US 2012/0245297 A1
(43) Pub. Date: Sep. 27, 2012

(54) MODIFIED PROPYLENE POLYMER

(75) Inventors: Hiroyoshi NAKAJIMA, Ichihara-shi (JP); Mitsuyoshi SHIMANO, Ichihara-shi (JP)

(73) Assignee: SUMITOMO CHEMICAL COMPANY, LIMITED, Tokyo (JP)

(21) Appl. No.: 13/425,611

(22) Filed: Mar. 21, 2012

(30) Foreign Application Priority Data
Mar. 25, 2011 (JP) 2011-067569

(51) Int. Cl. C08F 8/02

(52) U.S. Cl. 525/263

(57) ABSTRACT

Disclosed is a modified propylene polymer excellent in the balance between melt tension and flowability, the modified propylene polymer being obtainable by reacting 100 parts by weight of a propylene polymers (A), from 0.1 to 50 parts by weight of an ethylenically unsaturated bond-containing compounds (B), and from 0.01 to 20 parts by weight of an organic peroxide (C), wherein a melt flow rate measured at 230° C. under a load of 2.16 kg and a melt tension measured at 190° C. satisfy the following formula (1):

MT>9×MFR^{(-0.9)} (1).

### BACKGROUND OF THE INVENTION

1. Field of the Invention

The present invention relates to modified propylene polymers.

2. Description of Related Art

Modified polyolefin resins obtainable by grafting a polar monomer, such as maleic anhydride and glycidyl methacrylate, to propylene polymers have been known.

For example, patent document 1 has disclosed a modified propylene polymer obtainable by mixing a functional compound having a carboxylic acid group, a compound having in the molecule thereof two or more functional groups capable of reacting with a carboxylic acid, and an organic peroxide and then making them undergo a grafting reaction.

Patent document 2 has disclosed a modified propylene polymer obtainable by melt mixing a mixture containing a propylene polymer, a metal salt of (meth)acrylic acid, and an organic peroxide and then making them undergo a grafting reaction.

### RELATED ART DOCUMENTS

### Patent Documents

[Patent Document 1] JP 2003-171515 A
[Patent Document 2] JP 2009-179666 A

In a grafting reaction, the breakage of the molecular chain of a propylene polymer occurs simultaneously with the grafting reaction due to the use of an organic peroxide. As a result, the molecular weight of the modified propylene polymer obtained after the grafting reaction becomes remarkably low than the molecular weight of the propylene polymer before the modification, so that the flowability increases greatly and the melt tension decreases remarkably. For this reason, there has been a problem that the moldability of modified propylene polymers is inferior to that of propylene polymers and the mechanical properties which propylene polymers inherently have are not maintained.

The modified propylene polymer disclosed in patent document 1 has high melt tension, but the modified propylene polymer cannot be used with different types alloyed therewith because its carboxylic acids, which are polar components, have been reacted with other compounds of polymers to be consumed.

Moreover, the modified propylene polymer disclosed in patent document 2 has an increased grafted amount, but modified propylene polymers high in flowability have not been disclosed and the disclosed polymer is not necessarily satisfactory with respect to the balance between flowability and molt tension.

In light of the above-described problems, the object of the present invention is to provide modified propylene polymers excellent in the balance between melt tension and flowability.

### SUMMARY OF THE INVENTION

The present invention provides a modified propylene polymer obtainable by reacting 100 parts by weight of a propylene polymers (A), from 0.1 to 50 parts by weight, based on said 100 parts by weight, of an ethylenically unsaturated bond-containing compounds (B), and from 0.01 to 20 parts by weight, based on said 100 parts by weight, of an organic peroxide (C),

wherein a melt flow rate measured at 230° C. under a load of 2.16 kg and a melt tension measured at 190° C. satisfy the following formula (1):

MT>9×MFR^{(-0.9)} (1)

wherein MT is a melt tension and MFR is a melt flow rate.

According to the present invention, it becomes possible to provide modified propylene polymers excellent in the balance between melt tension and flowability.

### DESCRIPTION OF THE PREFERRED EMBODIMENTS

### Modified Propylene Polymer

The modified propylene polymer according to the present invention is a polymer obtainable by reacting a propylene polymer (A), an ethylenically unsaturated bond-containing compound (B), and an organic peroxide (C) together.

The melt flow rate (MFR) of the modified propylene polymer measured at 230° C. under a load of 2.16 kg load (in accordance with JIS K7210) is preferably from 0.1 to 400 g/10 minutes, more preferably from 0.5 to 300 g/10 minutes, and even more preferably from 1 to 200 g/10 minutes from the viewpoint of the molding processability of the modified propylene polymer.

Moreover, the melt flow rate and the melt tension (MT) of a modified propylene polymer satisfy the relation represented by following (1).

MT>9×MFR^{(-0.9)} (1)

If the relation between the melt flow rate and the melt tension deviates from the above-mentioned formula (1), the moldability of the modified propylene polymer will deteriorate. The relation between the melt flow rate and the melt tension is preferred MT>10×MFR^{(-0.9)} and more preferably MT>12×MFR^{(-0.9)}.

The grafted ratio of the ethylenically unsaturated bond-containing compound (B) to the propylene polymer (A), i.e., modification ratio, is preferably from 0.1 to 10% by weight, more preferably from 0.1 to 5% by weight, and even more preferably from 0.1 to 1% by weight.

The value determined using the infrared absorption spectrum of the modified propylene polymer is used as the modification ratio in the present invention.

The respective components will be described below.

### <Propylene Polymer (A)>

The propylene polymer (A) to be used in the present invention (hereinafter also called component (A)) refers to a propylene homopolymer or a copolymer of propylene and other monomers. These may be used singly or alternatively two or more of them may be blended for use. The aforementioned copolymer may be either a random copolymer or a block copolymer.

Examples of the random copolymer include a random copolymer composed of constitutional units derived from propylene and constitutional units derived from ethylene; a random copolymer composed of constitutional units derived from propylene and constitutional units derived from an α-olefin other than propylene; and a random copolymer composed of constitutional units derived from propylene, constitutional units derived from ethylene, and constitutional units derived from an α-olefin other than propylene.

Examples of the block copolymer include a polymeric material composed of a propylene homopolymer component or a polymer component composed of constitutional units derived from propylene (hereinafter referred to as polymer component (I)) and a copolymer component of propylene with ethylene and/or an α-olefin (hereinafter referred to as polymer component (II)).

From the viewpoint of the balance between the tensile strength and the impact resistance of the resin composition, the propylene polymer (A) preferably has an isotactic pentad fraction (sometimes written [mmmm] fraction) measured by ¹³C-NMR of 0.97 or more, more preferably 0.98 or more. It is a measure which indicates that the closer to 1 the isotactic pentad fraction of a propylene polymer (A) is, the higher is the regioregularity of the molecular structure of the highly crystalline polymer, i.e., the propylene resin (A).

When the propylene polymer (A) is a random copolymer like that mentioned above or a block copolymer like that mentioned above, a value measured for a chain of propylene units in the copolymer is used.

The melt flow rate (MFR) of the propylene copolymer (A) measured at 230° C. under a load of 2.16 kg is preferably from 0.05 to 500 g/10 minutes, more preferably from 1 to 120 g/10 minutes, even more preferably from 1 to 80 g/10 minutes, and most preferably from 5 to 50 g/10 minutes from the viewpoint of the balance between the tensile strength and the impact resistance of a resulting molded article and the molding processability of the resin composition.

The propylene polymer (A) can be produced by a method described below using a conventional polymerization catalyst.

Examples of the polymerization catalyst include Ziegler type catalyst systems, Ziegler-Natta type catalyst systems, catalyst systems composed of an alkyl aluminoxane and a compound of a transition metal of Group 4 of the periodic table which compound has a cyclopentadienyl ring, catalyst systems composed of an organoaluminum compound, a compound of a transition metal of Group 4 of the periodic table which compound has a cyclopentadienyl ring, and a compound capable of reacting with the compound of the transition metal to form an ionic complex, and catalyst systems prepared by modifying catalyst components such as a compound of a transition metal of Group 4 of the periodic table which compound has a cyclopentadienyl ring, a compound capable of forming an ionic complex, and an organoaluminum compound by supporting them on inorganic particles such as silica and clay mineral. Preliminarily polymerized catalysts which are prepared by preliminarily polymerizing ethylene or an α-olefin in the presence of the aforementioned catalyst systems may also be used.

Specific examples of the catalyst systems include the catalyst systems disclosed in JP 61-218606 A, JP 5-194685 A, JP 7-216017 A, JP 9-316147 A, JP 10-212319 A, and JP 2004-182981 A.

Examples of the polymerization method include bulk polymerization, solution polymerization, slurry polymerization, and vapor phase polymerization. The bulk polymerization is a method in which polymerization is carried out using, as a medium, an olefin that is liquid at the polymerization temperature, and the solution polymerization or the slurry polymerization is a method in which polymerization is carried out in an inert hydrocarbon solvent such as propane, butane, isobutane, pentane, hexane, heptane, and octane. The gas phase polymerization is a method in which a gaseous monomer is used as a medium and a gaseous monomer is polymerized in the medium.

Such polymerization methods may be conducted either in a batch system or in a multistage system using a plurality of polymerization reactors linked in series and these polymerization methods may be combined appropriately. From the industrial and economical point of view, a continuous vapor phase polymerization method or a bulk-vapor phase polymerization method in which a bulk polymerization method and a vapor phase polymerization method are used continuously is preferred.

The conditions of each polymerization step (polymerization temperature, polymerization pressure, monomer concentration, amount of catalyst to be charged, polymerization time, etc.) may be determined appropriately depending on the desired propylene polymer (A).

In the production of the propylene polymer (A), in order to remove a residual solvent contained in the propylene polymer (A) or ultra-low molecular weight oligomers formed during the production, the propylene polymer (A) may be dried at a temperature not higher temperature at which the propylene polymer (A) melts. Examples of the drying method include those disclosed in JP 55-75410 A and JP 2565753.

Random Copolymer

As described above, the random copolymer in the present invention includes random copolymers composed of constitutional units derived from propylene and constitutional units derived from ethylene; random copolymers composed of constitutional units derived from propylene and constitutional units derived from an α-olefin other than propylene; and random copolymers composed of constitutional units derived from propylene, constitutional units derived from ethylene, and constitutional units derived from an α-olefin other than propylene.

The α-olefin other than propylene which constitutes the random copolymer is preferably an α-olefin having from 4 to 10 carbon atoms, examples of which include 1-butene, 1-pentene, 1-hexene, 4-methyl-1-pentene, 1-octene and 1-decene and are preferably 1-butene, 1-hexene or 1-octene.

Examples of the random copolymer composed of constitutional units derived from propylene and constitutional units derived from α-olefin include propylene-1-butene random copolymers, propylene-1-hexene random copolymers, propylene-1-octene random copolymers, and propylene-1-decene random copolymers.

Examples of the random copolymer composed of constitutional units derived from propylene, constitutional units derived from ethylene, and constitutional units derived from an α-olefin include propylene-ethylene-1-butene random copolymers, propylene-ethylene-1-hexene random copolymers, propylene-ethylene-1-octene random copolymers, and propylene-ethylene-1-decene random copolymers.

The content of the constitutional units derived from ethylene and/or the α-olefin in the random copolymer is preferably from 0.1 to 40% by weight, more preferably from 0.1 to 30% by weight, and even more preferably from 2 to 15% by weight. The content of the constitutional units derived from propylene is preferably from 99.9 to 60% by weight, more preferably from 99.9 to 70% by weight, and even more preferably from 98 to 85% by weight.

Block Copolymer

As described above, the block copolymer in the present invention refers to a polymeric material composed of a propylene homopolymer component or a polymer component composed of constitutional units derived from propylene ((hereinafter referred to as polymer component (I)) and a copolymer component of propylene with ethylene and/or an α-olefin (hereinafter referred to as polymer component (II)).

The polymer component (I) is a propylene homopolymer component or a polymer component composed of constitutional units derived from propylene. Examples of the polymer component composed of constitutional units derived from propylene include a propylene copolymer component composed of units derived from at least one comonomer selected from the group consisting of ethylene and α-olefins having from 4 to 10 carbon atoms and units derived from propylene.

When the polymer component (I) is a polymer component composed of constitutional units derived from propylene, the content of the units derived from at least one comonomer selected from the group consisting of ethylene and α-olefins having from 4 to 10 carbon atoms is 0.01% by weight or more and less than 20% by weight where the weight of the polymer component (I) shall be 100% by weight.

1-Butene, 1-hexene, and 1-octene are preferred as the α-olefin having from 4 to 10 carbon atoms and 1-butene is more preferred.

Examples of the polymer component composed of constitutional units derived from propylene include propylene-ethylene copolymer components, propylene-1-butene copolymer components, propylene-1-hexene copolymer components, propylene-1-octene copolymer components, propylene-ethylene-1-butene copolymer components, propylene-ethylene-1-hexene copolymer components, and propylene-ethylene-1-octene copolymer components.

Examples of the polymer component (I) preferably include propylene homopolymer components, propylene-ethylene copolymer components, propylene-1-butene copolymer components, and propylene-ethylene-1-butene copolymer components.

The polymer component (II) is a copolymer component composed of constitutional units derived from at least one comonomer selected from the group consisting of ethylene and α-olefins having from 4 to 10 carbon atoms and constitutional units derived from propylene.

The content of the units derived from at least one comonomer selected from the group consisting of ethylene and α-olefins having from 4 to 10 carbon atoms contained in the polymer component (II) is from 20 to 80% by weight, preferably from 20 to 60% by weight, and more preferably from 30 to 60% by weight where the weight of the polymer component (II) shall be 100% by weight.

Examples of the α-olefin having from 4 to 10 carbon atoms that constitutes the polymer component (II) include α-olefins the same as the α-olefins having from 4 to 10 carbon atoms that constitute the aforementioned polymer component (I).

Examples of the polymer component (II) include propylene-ethylene copolymer components, propylene-ethylene-1-butene copolymer components, propylene-ethylene-1-hexene copolymer components, propylene-ethylene-1-octene copolymer components, propylene-ethylene-1-decene copolymer components, propylene-1-butene copolymer components, propylene-1-hexene copolymer components, propylene-1-octene copolymer components, and propylene-1-decene copolymer components; propylene-ethylene copolymer components, propylene-1-butene copolymer components, and propylene-ethylene-1-butene copolymer component are preferred, and propylene-ethylene copolymer components are more preferred.

The content of the polymer component (II) of the polymeric material composed of the polymer component (I) and the polymer component (II) is preferably from 1 to 50% by weight, more preferably from 1 to 40% by weight, even more preferably from 10 to 40% by weight, and most preferably from 10 to 30% by weight where the weight of the propylene polymer (A) shall be 100% by weight.

When the polymer component (I) of the propylene copolymer composed of the polymer component (I) and the polymer component (II) is a propylene homopolymer component, examples of the propylene copolymer include (propylene)-(propylene-ethylene) copolymers, (propylene)-(propylene-ethylene-1-butene) copolymers, (propylene)-(propylene-ethylene-1-hexene) copolymers, (propylene)-(propylene-ethylene-1-octene) copolymers, (propylene)-(propylene-1-butene) copolymers, (propylene)-(propylene-1-hexene) copolymers, (propylene)-(propylene-1-octene) copolymers, and (propylene)-(propylene-1-decene) copolymers.

When the polymer component (I) of the polymeric material composed of the polymer component (I) and the polymer component (II) is a propylene copolymer component composed of units derived from propylene, examples of the propylene copolymer composed of the polymer component (I) and the polymer component (II) include (propylene-ethylene)-(propylene-ethylene) copolymers, (propylene-ethylene)-(propylene-ethylene-1-butene) copolymers, (propylene-ethylene)-(propylene-ethylene-1-hexene) copolymers, (propylene-ethylene)-(propylene-ethylene-1-octene) copolymers, (propylene-ethylene)-(propylene-ethylene-1-decene) copolymers, (propylene-ethylene)-(propylene-1-butene) copolymers, (propylene-ethylene)-(propylene-1-hexene) copolymers, (propylene-ethylene)-(propylene-1-octene) copolymers, (propylene-ethylene)-(propylene-1-decene) copolymers, (propylene-1-butene)-(propylene-ethylene) copolymers, (propylene-1-butene)-(propylene-ethylene-1-butene) copolymers, (propylene-1-butene)-(propylene-ethylene-1-hexene) copolymers, (propylene-1-butene)-(propylene-ethylene-1-octene) copolymers, (propylene-1-butene)-(propylene-ethylene-1-decene) copolymers, (propylene-1-butene)-(propylene-1-butene) copolymers, (propylene-1-butene)-(propylene-1-hexene) copolymers, (propylene-1-butene)-(propylene-1-octene) copolymers, (propylene-1-butene)-(propylene-1-decene) copolymers, (propylene-1-hexene)-(propylene-1-hexene) copolymers, (propylene-1-hexene)-(propylene-1-octene) copolymers, (propylene-1-hexene)-(propylene-1-decene) copolymers, (propylene-1-octene)-(propylene-1-octene) copolymers, and (propylene-1-octene)-(propylene-1-decene) copolymers.

Preferred examples of the propylene copolymer composed of the polymer component (I) and the polymer component (II) include (propylene)-(propylene-ethylene) copolymers, (propylene)-(propylene-ethylene-1-butene) copolymers, (propylene-ethylene)-(propylene-ethylene) copolymers, (propylene-ethylene)-(propylene-ethylene-1-butene) copolymers, and (propylene-1-butene)-(propylene-1-butene) copolymer, and (propylene)-(propylene-ethylene) copolymers are more preferred.

The intrinsic viscosity ([η]I) of the polymer component (I) measured in tetralin of 135° C. is from 0.1 to 5 dl/g, preferably from 0.3 to 4 dl/g, and more preferably from 0.5 to 3 dl/g.

The intrinsic viscosity ([η]II) of the polymer component

(II) measured in tetralin of 135° C. is from 1 to 20 dl/g, preferably from 1 to 10 dl/g, and more preferably from 2 to 7 dl/g.

The ratio of the intrinsic viscosity of the polymer component (II) ([η]II) to the intrinsic viscosity of the polymer component (I) ([η]I) is preferably from 1 to 20, more preferably from 2 to 10, and even more preferably from 2 to 9.

The intrinsic viscosity [η] (unit: dl/g) in the present invention is a value measured by the method described below at a temperature of 135° C. using tetralin as a solvent.

Reduced viscosities are measured at three concentrations of 0.1 g/dl, 0.2 g/dl and 0.5 g/dl by using a Ubbelohde's viscometer. The intrinsic viscosity is calculated by the calculation method described in “Kobunshi Yoeki (Polymer Solution), Kobunshi Jikkengaku (Polymer Experiment Study) Vol. 11” page 491 (published by Kyoritsu Shuppan Co., Ltd., 1982), namely, by an extrapolation method in which reduced viscosities are plotted against concentrations and the concentration is extrapolated to zero.

When the propylene polymer (A) is a polymeric material to be obtained by producing the polymer component (I) and the polymer component (II) by multistage polymerization, the intrinsic viscosity of the polymer component (I) or the polymer component (II) is determined using a polymer powder extracted from the polymerization vessel of the first stage and then the intrinsic viscosity of the remaining component is calculated from the value of the previously determined intrinsic viscosity and the contents of the respective components.

Moreover, when the propylene copolymer composed of the polymer component (I) and the polymer component (II) is a copolymer such that the polymer component (I) is obtained by the polymerization step of the earlier stage and the polymer component (II) is obtained in the latter step, the procedures of the measurement and the calculation of the contents of the polymer component (I) and the polymer component (II) and the intrinsic viscosities ([η]Total, [η]I, [η]II) are as follows. The intrinsic viscosity ([η]Total) represents the intrinsic viscosity of the whole propylene polymer (A).

From the intrinsic viscosity of the polymer component (I) obtained by the polymerization step of the earlier stage ([η]I), the intrinsic viscosity of the last polymer after the polymerization step of the latter stage (component (I) and component (II)) measured by the above-described method ([η]Total), and the content of the polymer component (II) contained in the final polymer, the intrinsic viscosity of the polymer component (II) [η]II is calculated from the following formula:

[η]II=([η]Total−[η]I×XI)/XII

[η]Total: the intrinsic viscosity (dl/g) of the final polymer after the polymerization step of the latter stage

[η]I: the intrinsic viscosity (dl/g) of a polymer powder extracted from a polymerization reactor after the polymerization step of the earlier stage

XI: the weight ratio of polymer component (I) to the whole propylene polymer (A)

XII: the weight ratio of polymer component (II) to the whole propylene polymer (A)

XI and XII are calculated from the mass balance in the polymerizations.

The weight ratio (XII) of the polymer component (II) to the whole portion of the propylene polymer (A) can be determined by measuring the heat of crystal fusion of the propylene homopolymer component and that of the whole portion of the propylene polymer (A), followed by a calculation using the following formula. The heat of crystal fusion can be measured by differential scanning calorimetry (DSC).

XII=1−(ΔHf)Total/(ΔHf)

(ΔHf)Total: Heat of fusion (cal/g) of the whole portion of the propylene polymer (A)

(ΔHf): Heat of fusion (cal/g) of the propylene homopolymer component

The content ((Cα′)II) of the units derived from the comonomers of the polymer component (II) in the propylene polymer (A) was determined by measuring the content (Cα′) Total) of the units derived from the comonomers of the whole portion of the propylene polymer (A) by the infrared absorption spectrum method, followed by a calculation using the following formula.

(Cα′)II=(Cα′)Total/XII

(Cα′)Total: Content (% by weight) of the units derived from the comonomers of the whole portion of the propylene polymer (A)

(Cα′)II: Content (% by weight) of the units derived from the comonomers of the polymer component (II)

The block copolymer is obtained by producing the polymer component (I) in the first step and then producing the polymer component (II) in the second step. The polymerization is carried our using the above-described polymerization catalyst.

### <Ethylenically Unsaturated Bond-Containing Compound (B)>

The ethylenically unsaturated bond-containing compound (B) to be used in the present invention is a compound that has at least one ethylenically unsaturated bond and at least one kind of polar group. Examples thereof include unsaturated carboxylic acids and/or derivatives thereof, such as unsaturated carboxylic acids, ester compounds of unsaturated carboxylic acids, amide compounds of unsaturated carboxylic acids, and anhydrides of unsaturated carboxylic acids, unsaturated epoxy compounds, unsaturated alcohols, and unsaturated amine compounds.

More specific examples of the ethylenically unsaturated bond-containing compound (B) include:

(1) maleic acid, maleic anhydride, fumaric acid, maleimide, maleic hydrazide, methyl nadic anhydride, dichloromaleic anhydride, maleic amide, itaconic acid, itaconic anhydride, glycidyl (meth)acrylate, 2-hydroxyethyl methacrylate and allyl glycidyl ether,

(2) unsaturated carboxylic acids, such as acrylic acid, butenoic acid, crotonic acid, vinylacetic acid, methacrylic acid, pentenoic acid, angelic acid, tiglic acid, 2-pentenoic acid, 3-pentenoic acid, α-ethylacrylic acid, β-methylcrotonic acid, 4-pentenoic acid, 2-hexene, 2-methyl-2-pentenoic acid, 3-methyl-2-pentenoic acid, α-ethylcrotonic acid, 2,2-dimethyl-3-butenoic acid, 2-heptenoic acid, 2-octenoic acid, 4-decenoic acid, 9-undecenoic acid, 10-undecenoic acid, 4-dodecenoic acid, 5-dodecenoic acid, 4-tetradecenoic acid, 9-tetradecenoic acid, 9-hexadecenoic acid, 2-octadecenoic acid, 9-octadecenoic acid, eicosenoic acid, dococenoic acid, erucic acid, tetracosenoic acid, mycolipenic acid, a 2,4-hexadienoic acid, diallylacetic acid, geranium acid, 2,4-decadienoic acid, 2,4-dodecadienoic acid, 9,12-hexadecadienoic acid, 9,12-octadecadienoic acid, hexadecatrienoic acid, eicosadienoic acid, eicosatrienoic acid, eicosatetraenoic acid, ricinoleic acid, eleostearic acid, oleic acid, eicosapentaenoic acid, erucic acid, docosadienoic acid, docosatrienoic acid, docosatetraenoic acid, docosapentaenoic acid, tetracosenoic acid, hexacosenoic acid, hexacodienoic acid, octacosenoic acid, and tetracontenoic acid,

(3) ester compounds, amide compounds or anhydrides of the above-mentioned unsaturated carboxylic acids,

(4) unsaturated alcohols such as allyl alcohol, crotyl alcohol, methylvinylcarbinol, allylcarbinol, methylpropenylcarbinol, 4-penten-1-ol, 10-undecen-1-ol, propargyl alcohol, 1,4-pentadien-3-ol, 1,4-hexadien-3-ol, 3,5-hexadien-2-ol, and 2,4-hexadien-1-ol,

(5) unsaturated alcohols such as 3-butene-1,2-diol, 2,5-dimethyl-3-hexene-2,5-diol, 1,5-hexadiene-3,4-diol and 2,6-octadiene-4,5-diol, and

(6) unsaturated amines resulting from replacing the hydroxy groups of the above unsaturated alcohols with an amino group.

The ethylenically unsaturated bond-containing compound (B) is preferably an unsaturated carboxylic acid and/or a derivative thereof, such as maleic anhydride, maleic acid, fumaric acid, itaconic anhydride, itaconic acid, glycidyl (meth)acrylate, and 2-hydroxyethyl methacrylate, and maleic anhydride is particularly preferred.

The added amount of the ethylenically unsaturated bond-containing compound (B) is from 0.1 to 50 parts by weight based on 100 parts by weight of the propylene polymers (A), preferably from 0.1 to 20 parts by weight, more preferably from 0.1 to 10 parts by weight, and most preferably from 0.1 to 5 parts by weight. If the added amount is less than 0.1 parts by weight, the grafted ratio of the resulting modified propylene polymer to be obtained may lower. If the added amount exceeds 50 parts by weight, a bad influence may be exerted upon production, for example, an extruder will corrode during the grafting reaction.

### <Organic Peroxide (C)>

The organic peroxide (C) to be used in the present invention is an organic peroxide which decomposes to generate a radical and then works to remove a proton from the propylene polymer (A). In view of the action to remove a proton at the heat treatment temperature of the present invention, the organic peroxide (C) is preferably one whose decomposition temperature at which the half-life thereof becomes 1 minute is lower than 120° C., more preferably lower than 100° C.

Specifically, the organic peroxide (C) is preferably at least one compound selected from the group consisting of diacyl peroxide compounds, compounds (b1) having a structure represented by the following structural formula (1), and compounds (b2) having a structure represented by the following structural formula (2).

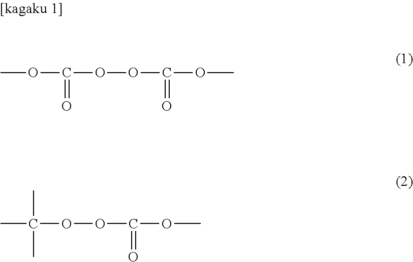

Examples of the diacyl peroxide compounds include dibenzoyl peroxide, diisobutyryl peroxide, di(3,5,5-trimethylhexanoyl) peroxide, di(4-methylbenzoyl) peroxide, and didodecanoyl peroxide.

Examples of the compounds (b1) having a structure represented by the following structural formula (1) include dicetyl peroxydicarbonate, di-3-methoxybutyl peroxydicarbonate, di-2-ethylhexyl peroxydicarbonate, bis(4-tert-butylcyclohexyl) peroxydicarbonate, diisopropyl peroxydicarbonate, tert-butylperoxyisopropyl carbonate, and dimyristyl peroxycarbonate.

Examples of the compounds (b2) having a structure represented by the following structural formula (2) include 1,1,3,3-tetramethylbutyl neodecanoate, α-cumylperoxy neodecanoate, and tert-butylperoxy neodecanoate.

The added amount of the organic peroxide (C) is from 0.01 to 20 parts by weight, preferably from 0.01 to 10 parts by weight, and more preferably from 0.1 to 5 parts by weight relative to 100 parts by weight of the propylene polymer (A). If the added amount is less than 0.01 parts by weight, the grafted ratio of the resulting modified propylene polymer to be obtained may lower. If the added amount exceeds 20 parts by weight, a bad influence may be exerted upon productivity, for example, an extruder will corrode during the grafting reaction.

### [Method for Producing of a Modified Propylene Polymer]

A method for producing the modified propylene polymer according to the present invention has a mixing step of mixing a propylene polymer (A), an ethylenically unsaturated bond-containing compounds (B), and an organic peroxide (C) and a heat treatment step of heat treating the mixture obtained by the mixing step at a prescribed temperature by using an extruder. The respective steps will be described below.

### <Mixing Step>

The mixing step is a step of mixing 100 parts by weight of the propylene polymer (A) described below, from 0.1 to 50 parts by weight, based on said 100 parts by weight, of an ethylenically unsaturated bond-containing compounds (B), and from 0.01 to 20 parts by weight, based on said 100 parts by weight, of an organic peroxide (C). It is preferred to mix the respective ingredients uniformly by using a device such as a Henschel mixer and a blender. The mixing of the ingredients is carried out preferably at a temperature lower than the decomposition of the organic peroxide (C) at which the half-life thereof becomes 1 minute, preferably for 1 second to 1 hour, more preferably from 1 to 5 minutes.

### <Heat Treatment Step>

The heat treatment step is a step of subjecting a mixture obtained by the above-described mixing step to heat treatment at a prescribed temperature by using an extruder. By performing heat treatment using an extruder, the organic peroxide (B) in the mixture decomposes and a free radical formed by the decomposition reacts with the propylene polymer (A) and a free radical generated in the propylene polymer (A) reacts with an ethylenically unsaturated bond-containing compound (B), so that it becomes possible to obtain a modified propylene polymer whose melt tension has been increased.

The heat treatment temperature is preferably a temperature lower than the decomposition temperature of the organic peroxide (C) at which the half-life thereof becomes 1 minute, and it is more preferably from the glass transition temperature of the propylene polymer (A) to the decomposition temperature of organic peroxide (C) at which the half-life thereof becomes 1 minute, even more preferably from the glass transition temperature of the propylene polymer (A) to 100° C., and still more preferably from 20 to 80° C. If the heat treatment temperature exceeds the decomposition temperature of organic peroxide (C) at which the half-life thereof becomes 1 minute, the propylene polymer (A) will decompose, so that the melt flow rate of the resulting modified propylene polymer will become high. The load to be applied to an extruder can be reduced by adjusting the heat treatment temperature to 20° C. or higher. The heat treatment temperature as used in the present invention is the temperature of the cylinder (the temperature of the kneading part) of an extruder.

The heat treatment time (the residence time of resin in an extruder) is from 0.1 to 30 minutes and preferably from 0.5 to 10 minutes.

Example of extruders that can be as the extruder to be used in the heat treatment step include a single screw extruder, a twin screw extruder, a multi-screw extruder, and the like and, in addition, a kneader, a Banbury mixer, a Brabender plastograph, and the like. Moreover, an extruder having a solid phase shear region like those disclosed in U.S. Pat. No. 4,607,797 and U.S. Pat. No. 6,494,390 and an extruder having a melt kneading region in addition to a solid phase shear region like that disclosed in JP 2005-281379 A may be used.

Furthermore, a high shear kneading machine equipped with an internal feedback screw can be used (see JP 2005-313608 A). In particular, it is preferred to use an extruder by which production can be done continuously.

Two or more types of extruders selected from among the above may be used together. For example, it is permitted to separate a kneading step and an extrusion step with two types of extruders arranged consecutively (tandem type, etc.). An extruder having two or more raw material feed port may be used.

The extruder preferably has a raw material feed part, a kneading part, a vent part, and an extrusion part. From the viewpoint of productivity, the cylinder temperature of the vent part and the extrusion part is preferably from 100 to 300° C., more preferably from 140 to 250° C. From the viewpoint of the removal of heat generated by shearing, it is preferred that the screw and the cylinder can be cooled with a refrigerant, such as water.

Examples of the shape of the modified propylene polymer include a strand shape, a sheet shape, a flat shape, and a pellet shape produced by cutting a strand. In order to mold the modified propylene polymer of the present invention to molding, it is preferable, from the viewpoint of the production stability of molded articles to be obtained, that the polymer be in the form of pellets having a length of from 1 to 50 mm.

### <Additives>

Additives may be used for the production of a modified propylene polymer according to the present invention. Examples of the additives include a neutralizer, an antioxidant, a UV absorber, a lubricant, an antistatic agent, an antiblocking agent, a processing aid, a coloring agent, a foaming agent, a foam nucleating agent, a plasticizer, a flame retardant, a crosslinking agent, a crosslinking aid, a brightening agent, an antibacterial agent, and a light diffusing agent. Such additives may be used singly or two or more of them may be used in combination.

The resin composition according to the present invention may contain a resin or a rubber component other than the above-described propylene polymer (A).

Examples thereof include ABS (copolymerized acrylonitrile/butadiene/styrene) resin, AAS (copolymerized special acrylic rubber/acrylonitrile/styrene) resin, ACS (copolymerized acrylonitrile/chlorinated polyethylene/styrene) resin, polychloroprene, chlorinated rubber, poly(vinyl chloride), poly(vinylidene chloride), fluororesin, polyacetal, polysulfone, polyetheretherketone, and polyethersulfone.

Modified propylene polymers according to the present invention can be used for blow molding, sheet forming, laminate forming, and expansion molding.

### EXAMPLES

The present invention is further described below with reference to Examples and Comparative Examples. The propylene polymers (A), ethylenically unsaturated bond-containing compound (B), and organic peroxide (C) used in the Examples and the Comparative Examples are given below.

Propylene Polymer (A)

### (A-1) Propylene Homopolymer

Melt flow rate (at 230° C. under a load of 2.16 kgf): 18 g/10 minutes

Intrinsic viscosity ([η]): 1.34 dl/g

### (A-2) Propylene Homopolymer

Melt flow rate (at 230° C. under a load of 2.16 kgf): 105 g/10 minutes

Intrinsic viscosity ([η]): 0.93 dl/g

Ethylenically Unsaturated Bond-Containing Compound (B)

Compound name: Maleic anhydride (MAH)

Organic Peroxide (C)

Compound name: Dicetyl peroxydicarbonate

Decomposition temperature at which the half-life becomes 1 minute: 99° C.

The physical properties of raw material components and modified propylene polymers were measured in accordance with the methods given below.

(1) Melt flow rate (MFR; unit: g/10 minutes)

The melt flow rates of raw material components and modified propylene polymers were measured in accordance with the method provided in JIS K7210. The measurement was performed at a temperature of 230° C. under a load of 2.16 kg.

(2) Intrinsic viscosity ([η], unit: dl/g)

The intrinsic viscosity of a raw material component was measured in the following procedures. First, reduced viscosities were measured at three concentrations of 0.1, 0.2 and 0.5 g/dl by using a Ubbelohde's viscometer. Then, the intrinsic viscosity was determined by an extrapolation method in which reduced viscosities are plotted against concentrations and the concentration is extrapolated to zero as described before. The measurement was carried out in tetralin of 135° C.

(3) Modification ratio with maleic anhydride (% by weight)

The modified propylene polymer (1.0 g) obtained in each of the Examples and the Comparative Examples was dissolved in 100 ml of xylene. This solution was dropped into 1000 ml of methanol under stirring and then a modified propylene polymer reprecipitated was collected. The modified propylene polymer collected was vacuum dried (at 80° C. for 8 hours) and a film of about 100 μm in thickness was produced by heat pressing. The infrared absorption spectrum of the thus-produced film was measured and the absorbance of a characteristic absorption of the resulting infrared absorption spectrum was corrected with the thickness of the sheet used for the measurement. Then, a modification ratio with maleic anhydride was determined by a calibration curve method on the basis of the corrected absorbance. A peak of 1780 cm⁻¹ was used as the characteristic absorption of maleic anhydride.

(4) Melt tension (MT, unit: cN)

As to the melt tension of a modified propylene polymer, by the use of a melt tension analyzer manufactured by Toyo Seiki Seisaku-sho, Ltd., the modified propylene polymer was melt extruded through an orifice with a diameter of 2.095 mm and a length of 8 mm at a temperature of 190° C. and an extrusion rate of 5.7 mm/min, the extruded modified propylene polymer was hauled-off with a haul-off roll at a hauling-off rate of 15.7 m/min into a filament form, and then the tension applied during the hauling-off was measured. The average of the maximum tension and the minimum tension detected during the hauling off was used as the melt tension.

### Example 1, Comparative Example 1

A modified propylene polymer was obtained by uniformly mixing a propylene polymer (A), an ethylenically unsaturated bond-containing compounds (B), and an organic peroxide (C), followed by performing heat treatment under the condition given in Table 1 using an extruder. A single screw extruder was used as the extruder. The preset temperature of the cylinder was 80° C. and the preset screw rotation speed was 75 rpm. The blend ratio of the propylene polymer (A), the ethylenically unsaturated bond-containing compounds (B), and the organic peroxide (C) and the physical properties of the resulting modified propylene polymer (A) are given in Table 1.

### Examples 2 to 5, Comparative Example 2

Modified propylene polymers were obtained in the same way as Example 1 except for setting the preset temperature of the cylinder to 40° C. and setting the screw rotation speed to 65 rpm in the respective examples. Physical properties of the resulting modified propylene polymers are shown in Table 1.

### Comparative Examples 3 to 6

As an extruder, modified propylene polymers were obtained in the same way as Example 1 except for using a twin screw extruder (Model TEX44αII-49BW-3V, manufactured by The Japan Steel Works, Ltd.) as an extruder. The cylinder temperature of the extruder was adjusted to 200° C. and the screw rotation speed was adjusted to 200 rpm.

TABLE 1

| | (A-1) | (A-2) | (B) | (C) | Heat | MFR | Modification | |
|---|---|---|---|---|---|---|---|---|
| | part by | part by | part by | part by | treatment | g/10 | ratio | MT |
| | weight | weight | weight | weight | temperature | minutes | % by weight | cN |
| Example 1 | 100 | | 2 | 1 | 80 | 21.6 | 0.12 | 1.5 |
| Example 2 | 100 | | 2 | 1 | 40 | 24.4 | 0.14 | 1.6 |
| Example 3 | 100 | | 2 | 2 | 40 | 21.5 | 0.24 | 1.5 |
| Example 4 | | 100 | 2 | 1 | 40 | 138 | 0.13 | 0.2 |
| Example 5 | | 100 | 2 | 2 | 40 | 153 | 0.25 | 0.3 |
| Comparative | 100 | | 2 | | 80 | 19.9 | 0.01 | 0.4 |
| Example 1 | | | | | | | | |
| Comparative | 100 | | 2 | | 40 | 20.7 | 0.02 | 0.4 |
| Example 2 | | | | | | | | |
| Comparative | 100 | | | | 200 | 17.8 | 0.00 | 0.4 |
| Example 3 | | | | | | | | |
| Comparative | 100 | | 2 | 1 | 200 | 563 | 0.30 | Nonmeasurable |
| Example 4 | | | | | | | | |
| Comparative | | 100 | 2 | 1 | 200 | 360 | 0.10 | Nonmeasurable |
| Example 5 | | | | | | | | |
| Comparative | | 100 | 2 | 2 | 200 | 349 | 0.19 | Nonmeasurable |
| Example 6 | | | | | | | | |

1. A modified propylene polymer obtainable by reacting 100 parts by weight of a propylene polymers (A), from 0.1 to 50 parts by weight, based on said 100 parts by weight, of an ethylenically unsaturated bond-containing compounds (B), and from 0.01 to 20 parts by weight, based on said 100 parts by weight, of an organic peroxide (C),
wherein a melt flow rate measured at 230° C. under a load of 2.16 kg and a melt tension measured at 190° C. satisfy the following formula (1):
MT>9×MFR^{(-0.9)} (1)
wherein MT is a melt tension and MFR is a melt flow rate.

2. The modified propylene polymer according to claim 1, wherein the decomposition temperature at which the half-life of the organic peroxide becomes 1 minute is lower than 120° C.

3. The modified propylene polymer according to claim 1, wherein the ethylenically unsaturated bond-containing compound (B) is at least one member selected from the group consisting of maleic anhydride, maleic acid, fumaric acid, itaconic anhydride, itaconic acid, glycidyl (meth)acrylate, and 2-hydroxyethyl methacrylate.

4. The modified propylene polymer according to claim 2, wherein the ethylenically unsaturated bond-containing compound (B) is at least one member selected from the group consisting of maleic anhydride, maleic acid, fumaric acid, itaconic anhydride, itaconic acid, glycidyl (meth)acrylate, and 2-hydroxyethyl methacrylate.
